(19) United States
(12) Patent Application Publication
(10) Pub. No.: US 2016/0150738 A1
(43) Pub. Date: Jun. 2, 2016

(54) CUTTING ASSEMBLY

(71) Applicant: Brian Hall, Rio Dell, CA (US)

(72) Inventor: Brian Hall, Rio Dell, CA (US)

(21) Appl. No.: 14/557,531

(22) Filed: Dec. 2, 2014

(51) Int. Cl. A01G 3/037; B26B 15/00

(52) U.S. Cl. CPC A01G 3/037; B26B 15/00

(57) ABSTRACT

A cutting assembly includes a housing. A fixed blade and a pivotal blade is each coupled to the housing to engage a plant. A drive is positioned within the housing. The drive engages the pivotal blade, urging the pivotal blade toward the fixed blade to cut the plant. An actuator is coupled to the housing and the drive. The actuator actuates the drive. A control is coupled to the housing and the drive. The control adjusts a speed of the drive.

### BACKGROUND OF THE DISCLOSURE

### Field of the Disclosure

The disclosure relates to cutting devices and more particularly pertains to a new cutting device having an adjustable speed to trim plants.

### SUMMARY OF THE DISCLOSURE

An embodiment of the disclosure meets the needs presented above by generally comprising a housing. A fixed blade and a pivotal blade is each coupled to the housing to engage a plant. A drive is positioned within the housing. The drive engages the pivotal blade, urging the pivotal blade toward the fixed blade to cut the plant. An actuator is coupled to the housing and the drive. The actuator actuates the drive. A control is coupled to the housing and the drive. The control adjusts a speed of the drive.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a cutting assembly according to an embodiment of the disclosure.

FIG. 2 is a top view of an embodiment of the disclosure.

FIG. 3 is a left side view of an embodiment of the disclosure.

FIG. 4 is a cross sectional view taken along line 4-4 of FIG. 2 of an embodiment of the disclosure.

### DESCRIPTION OF THE PREFERRED EMBODIMENT

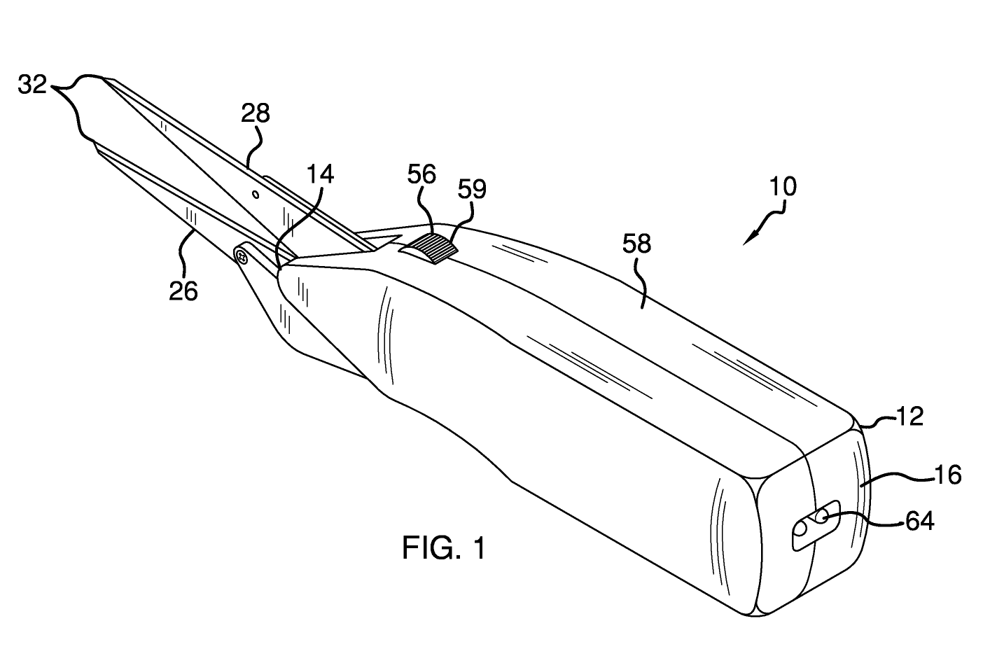

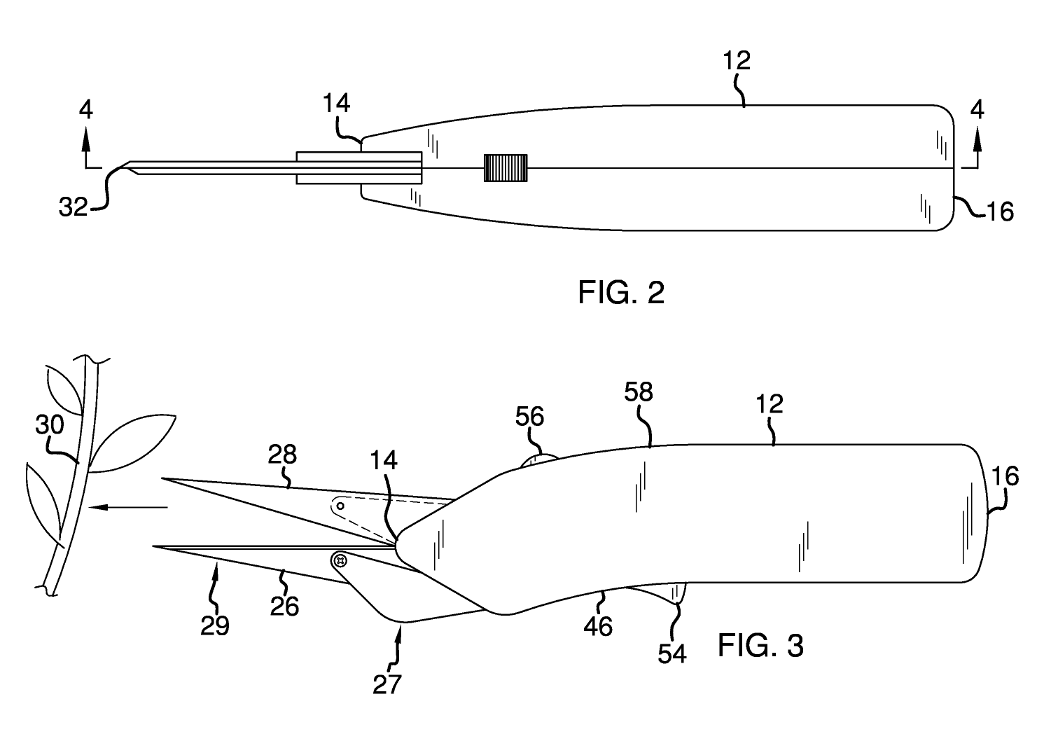

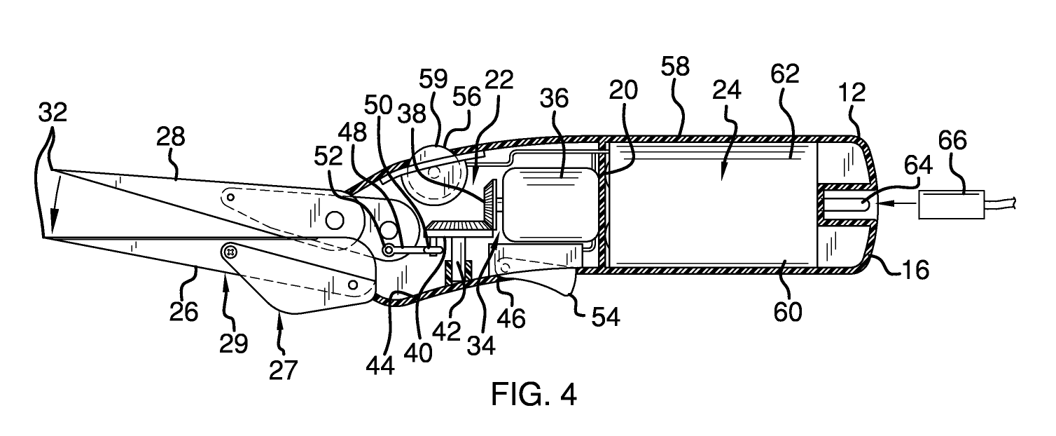

With reference now to the drawings, and in particular to FIGS. 1 through 4 thereof, a new cutting device embodying the principles and concepts of an embodiment of the disclosure and generally designated by the reference numeral 10 will be described.

As best illustrated in FIGS. 1 through 4, the cutting assembly 10 generally comprises a housing 12 that has a front end 14, a back end 16 and a perimeter wall 18 extending between the front 14 and back 16 ends. The housing 12 has a dividing wall 20 positioned within an interior of the housing 12. The dividing wall 20 is centrally positioned within the housing 12 to define a motor space 22 and a power supply space 24.

A fixed blade 26 and a pivotal blade 28 are each coupled to the housing 12. Each of the blades 26,28 includes a cutting portion 27 and a coupling portion 29. The blades 26,28 may engage a plant 30. The plant 30 may be a shrub, tree or the like. The blades 26,28 are positioned on the front end 14 such that the blades 26,28 extend forwardly from the housing 12. Each of the blades 26,28 has a free end 32. The fixed 26 and the pivotal 28 blades may each be curved adjacent to the free ends 32.

A drive 34 is positioned within the housing 12. The drive 34 engages the pivotal blade 28 such that the drive 34 urges the pivotal blade 28 toward the fixed blade 26. The blades 26,28 may cut the plant 30. The drive 34 comprises a motor 36 coupled to the dividing wall 20 such that the motor 36 is positioned within the motor space 22. The motor 36 may be an electrical motor or the like.

A first gear 38 is coupled to motor 36 such that the motor 36 rotates the first gear 38. A second gear 40 is provided. A shaft 42 is rotatably coupled to an inside surface 44 of a bottom side 46 of the perimeter wall 18 of the housing 12. The second gear 40 is coupled to the shaft 42 such that the second gear 40 is positioned within the motor space 22. The second gear 40 engages the first gear 38 such that the first gear 38 rotates the second gear 40.

A linkage 48 is provided. The linkage 48 has a first end 50 and a second end 52. The first end 50 of the linkage 48 is coupled to the second gear 40. The linkage 48 is alternately urged forwardly and rearwardly in the housing 12 when the second gear 40 rotates. The second end 52 of the linkage 48 is coupled to the coupling portion 29 of the pivotal blade 28. The linkage 48 repeatedly moves the pivotal blade 28 downwardly toward the fixed blade 26 and upwardly away from the fixed blade 26 when the second gear 40 rotates.

An actuator 54 is coupled to the bottom side 46 of the perimeter wall 18 of the housing 12. The actuator 54 is electrically coupled to the motor 36 such that the actuator 54 selectively actuates and de-actuates the motor 36. A control 56 is coupled to a top side 58 of the perimeter wall 18 of the housing 12. The control 56 is electrically coupled to the motor 36 such that the control 56 adjusts a rotational speed of the motor 36 between a minimum speed and a maximum speed. The control 56 comprises a wheel 59 that is rotatable with respect to the housing 12.

A power supply 60 is positioned within the power supply space 24. The power supply 60 is electrically coupled to the motor 36. The power supply 60 comprises at least one battery 62. A charge port 64 is recessed into the back end 16 of the housing 12. The charge port 64 is electrically coupled to the power supply 60. The charge port 64 is electrically coupled to a power source 66 in order to charge the power supply 60. The power source 66 may be a charger of any conventional design.

In use, the assembly 10 is utilized in the convention of landscaping and grooming of plants. The control 56 is rotated to select an optimal speed to accommodate various types of plants, thereby providing a more accurate and clean cut. The maximum speed is selected for small plants without a woody stem. The minimum speed is selected for large plants that have a woody stem.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cutting assembly configured to cut a plant, said assembly comprising:
a housing;
a fixed blade and a pivotal blade each coupled to said housing wherein said blades are configured to engage a plant;
a drive positioned within said housing, said drive engaging said pivotal blade such that said drive urges said pivotal blade toward said fixed blade wherein said blades are configured to cut the plant;
an actuator coupled to said housing and said drive, said actuator actuating said drive; and
a control coupled to said housing and said drive, said control adjusting a speed of said drive.

2. The assembly according to claim 1, wherein having a front end, a back end and a perimeter wall extending between said front and back ends, said housing having a dividing wall positioned within an interior of said housing, said dividing wall being centrally positioned within said housing to define a motor space and a power supply space.

3. The assembly according to claim 2, wherein said blades being positioned on said front end such that said blades extend forwardly from said housing.

4. The assembly according to claim 2, wherein said drive comprising a motor coupled to said dividing wall such that said motor is positioned within said motor space.

5. The assembly according to claim 4, wherein a first gear coupled to motor such that said motor rotates said first gear.

6. The assembly according to claim 5, wherein a second gear rotatably coupled to said housing such that said second gear is positioned within said motor space, said second gear engaging said first gear such that said first gear rotates said second gear.

7. The assembly according to claim 6, wherein a linkage having a first end and a second end, said first end of said linkage being coupled to said second gear such that said linkage is alternately urged forwardly and rearwardly in said housing when said second gear rotates, said second end of said linkage being coupled to said pivotal blade such that said linkage moves said pivotal blade downwardly toward said fixed blade when said second gear rotates.

8. The assembly according to claim 4, wherein said actuator being electrically coupled to said motor such that said actuator selectively actuates and de-actuates said motor.

9. The assembly according to claim 1, wherein said control being electrically coupled to said motor such that said control adjusts a rotational speed of said motor between a minimum speed and a maximum speed, said control comprising a wheel being rotatable with respect to said housing.

10. The assembly according to claim 2, wherein a power supply positioned within said power supply space, said power supply being electrically coupled to said motor, said power supply comprising at least one battery.

11. A cutting assembly configured to cut a plant, said assembly comprising:
a housing having a front end, a back end and a perimeter wall extending between said front and back ends, said housing having a dividing wall positioned within an interior of said housing, said dividing wall being centrally positioned within said housing to define a motor space and a power supply space;
a fixed blade and a pivotal blade each coupled to said housing wherein said blades are configured to engage a plant, said blades being positioned on said front end such that said blades extend forwardly from said housing;
a drive positioned within said housing, said drive engaging said pivotal blade such that said drive urges said pivotal blade toward said fixed blade wherein said blades are configured to cut the plant, said drive comprising
a motor coupled to said dividing wall such that said motor is positioned within said motor space,
a first gear coupled to motor such that said motor rotates said first gear;
a second gear rotatably coupled to said housing such that said second gear is positioned within said motor space, said second gear engaging said first gear such that said first gear rotates said second gear, and
a linkage having a first end and a second end, said first end of said linkage being coupled to said second gear such that said linkage is alternately urged forwardly and rearwardly in said housing when said second gear rotates, said second end of said linkage being coupled to said pivotal blade such that said linkage moves said pivotal blade downwardly toward said fixed blade when said second gear rotates;
an actuator coupled to said housing wherein said actuator is configured to be engaged by a user, actuator being electrically coupled to said motor such that said actuator selectively actuates and de-actuates said motor;
a control coupled to said housing wherein said control is configured to be rotated by the user, said control being electrically coupled to said motor such that said control adjusts a rotational speed of said motor between a minimum speed and a maximum speed, said control comprising a wheel being rotatable with respect to said housing; and
a power supply positioned within said power supply space, said power supply being electrically coupled to said motor, said power supply comprising at least one battery.
